(19) United States
(12) Patent Application Publication
(10) Pub. No.: US 2026/0154770 A1
(43) Pub. Date: Jun. 4, 2026

(54) SYSTEMS AND METHODS FOR PLAN DETERMINATION

(71) Applicant: VIA TRANSPORTATION, INC., New York, NY (US)

(72) Inventors: Ioannis SIMAIAKIS, New York, NY (US); Shmulik MARCOVITCH, Kfar Saba (IL); Shahar CHEN, Tel Aviv (IL); Yagil ENGEL, New York, NY (US); Oren SHOVAL, Jerusalem (IL); Daniel RAMOT, New York, NY (US)

(73) Assignee: VIA TRANSPORTATION, INC., New York, NY (US)

(21) Appl. No.: 19/460,833

(22) Filed: Jan. 27, 2026

Related U.S. Application Data
(63) Continuation of application No. 17/737,520, filed on May 5, 2022, now Pat. No. 12,572,995.
(60) Provisional application No. 63/185,892, filed on May 7, 2021.

(51) Int. Cl. G06Q 50/40; G06Q 10/0631

(52) U.S. Cl. CPC G06Q 50/40; G06Q 10/06311

(57) ABSTRACT

Systems and methods for determining plans for ridesharing vehicle shifts for a plurality of ride requests that can provide an optimal plan are provided. The systems and methods can involve iteratively planning shifts such that a maximal number of rides can be schedules within a shift within one or more limitations.

### CROSS REFERENCE TO RELATED APPLICATIONS

This application is a continuation of U.S. patent application Ser. No. 17/737,520, filed on May 5, 2022, which claims the benefit of and priority to U.S. Provisional Patent Application No. 63/185,892, filed May 7, 2021, the entire contents of which are owned by the assignee of the instant application and incorporated herein by reference in their entirety.

### FIELD OF THE INVENTION

The invention relates generally to vehicle ridesharing and systems and methods for ridesharing management.

### BACKGROUND OF THE INVENTION

Recent years have witnessed increasing interest and development in the field of vehicle sharing, where one or more riders may share the same vehicle for a portion of their rides. Ridesharing may save ride costs, increase vehicle utilization, and reduce air pollution. A rider may use a ridesharing service through a ridesharing service application accessed by the rider's mobile device.

Ridesharing service can be performed with a car, van, and/or bus. Ridesharing service can include scheduling pickup-drop offs of riders, determining routes for vehicles, modifying routes for vehicles on the fly. Ridesharing services can operate as fixed route, semi-fixed route, and/or full point-to-point services, and vehicles can be commanded to operate in any of those modes and/or be switched between those service types.

Currently, typically ridesharing management systems receive a list of ride requests (e.g., a list or request for the following day), and schedule them for the next day within a number of driver shifts available from a set of prescheduled drivers. This can cause an excess or shortage of drivers if, for example, the list of ride requests is smaller or larger in comparison to the number of drivers, and/or cause scheduling inefficiencies. Therefore, it can be desirable for rideshare management systems to create a plan for driver shifts that meets the list of ride requests in an optimal amount of time with an optimal number of driver shifts.

### SUMMARY

Advantages of the invention can include creating a plan for driver shifts that meets the list of ride requests in an optimal amount of time with an optimal number of driver shifts.

In one aspect, the invention involves a system for managing a fleet of ridesharing vehicles. The system includes a communications interface configured to a plurality of ride requests from a plurality of users. The system also includes at least one processor configured to i) determine a plan for a shift of a ridesharing vehicle wherein the plan is based on the plurality of ride requests, a duration of the shift for the ridesharing vehicle and one or more limitations of the ridesharing vehicles, wherein the plan results in assigning a subset of the plurality of ride requests to the shift ii) removing the subset of the plurality of ride requests from the plurality of ride requests and iii) if there are remaining unassigned plurality of ride requests, returning to step i), otherwise, transmitting each determined plan to each of the respective ridesharing vehicles.

In some embodiments, the plurality of ride requests are received over a predefined time duration. In some embodiments, the plurality of ride requests includes pick-up time and pick-up location. In some embodiments, each plan includes a start time, an end time, a driver start break time and a driver end break time. In some embodiments, the one or more limitations includes a maximum duration a driver can continuously drive, a number of breaks, a duration for each break, minimal time for a shift, total length of the shift, or any combination thereof.

In some embodiments, to determine a plan, the processor is further configured to segment the shift and determine an optimal shift from the segments, wherein segmenting is based on when the vehicle is empty, before every pick up and drop off, after a predetermined duration or any combination thereof, and wherein determining an optimal shift is based on a distance of each segment's potential first pick-up location to a nearest vehicle depot, distance for each potential last drop-off to a nearest vehicle depot, utilizations for the segment, shift length or any combination thereof.

In some embodiments, the processor is further configured to assign each determined plan to a corresponding vehicle.

In another aspect, the invention involves a method for managing a fleet of ridesharing vehicles. The method involves receiving, via a communications interface, a plurality of ride requests from a plurality of users. The method involves determining, via a processor, a plan for a shift of the ridesharing vehicle wherein the plan is based on the plurality of ride requests, a duration of the shift for the ridesharing vehicle and one or more limitations of the ridesharing vehicles, wherein the plan results in assigning a subset of the plurality of ride requests to the shift. The method involves removing, via the processor the subset of the plurality of ride requests from the plurality of ride requests. The method involves if there are remaining unassigned plurality of ride requests, returning to step, otherwise, transmitting each determined plan to each of the respective ridesharing vehicles.

In some embodiments, the plurality of ride requests are received over a predefined time duration. In some embodiments, the plurality of ride requests includes pick-up time and pick-up location. In some embodiments, each plan includes a start time, an end time, a driver start break time and a driver end break time. In some embodiments, the one or more limitations includes a maximum duration a driver can continuously drive, a number of breaks, a duration for each break, minimal time for a shift, total length of the shift, or any combination thereof.

In some embodiments, determining a plan further comprises segmenting the shift and determine an optimal shift from the segments, wherein segmenting is based on when the vehicle is empty, before every pick up and drop off, after a predetermined duration or any combination thereof, and wherein determining an optimal shift is based on a distance of each segment's potential first pick-up location to a nearest vehicle depot, distance for each potential last drop-off to a nearest vehicle depot, utilizations for the segment, shift length or any combination thereof.

In some embodiments, the method involves assigning each determined plan to a corresponding vehicle.

The foregoing general description and the following detailed description are exemplary and explanatory only and are not restrictive of the claims.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a ridesharing management system, according to some embodiments of the invention.

FIG. 2 is a diagram of a mobile communications device associated with a ridesharing management system, according to some embodiments of the invention.

FIG. 3 is a diagram of an automated ridesharing dispatch system, including ridesharing management server associated with a ridesharing management system, according to some embodiments of the invention.

FIG. 4 is a flow diagram for a method of managing a fleet of ridesharing vehicles, according to some embodiments of the invention.

FIG. 5 shows a graph of a plan for an entire shift and an optimal segment, according to some embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

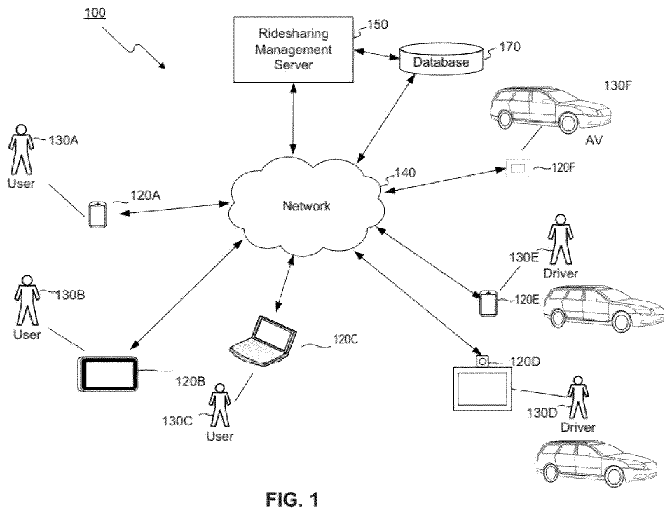

FIG. 1 is a diagram of a ridesharing management system 100, according to some embodiments of the invention. The ridesharing management system 100 includes one or more user devices 120A-120F (collectively referred to as user devices 120) associated with respective users 130A-130F, a network 140, a ridesharing management server 150, and a database 170. The user devices 120 can be mobile communications devices.

The users 130A-130F can be riders, drivers and/or other computing systems. In FIG. 1, users 130A-130C are riders, users 130D-130E are drivers, and user 130F is an autonomously driven vehicle user. The user devices 120A-120F can be associated with riders, drivers, and/or other computing systems, such that user devices 120A-120C can be referred to as rider devices, 120D-120E can be referred to as driver devices, and user device 120F can be referred to as a driving-control device.

The network 140 can be coupled to the user devices 120 to facilitate communications between the user devices 120 and the ridesharing management server 150. For example, the rider 130A can request a ride via the rider device 120A that is a smart phone. The request can be transmitted by the user device 120A to the ridesharing management server 150 through the network 140. The ridesharing management server 150 can transmit a route to the driver device 120E to instruct the driver 130E to pick-up the rider 130A. The ridesharing management server 150 can transmit a message to the rider 130A via the rider device 120A indicating that the driver 130E is on its way and the message can instruct the rider 130A to a particular pick-up location.

The network 140 can facilitate communications that include receiving ride requests and/or other ride related input from or sending confirmations to the rider devices 120A-120C and/or sending ride service assignments to the driver devices 120D-120E and driving-control device 120F.

The network 140 can be any type of network that provides communications, exchanges information, and/or facilitates the exchange of information between ridesharing management server 150 and user devices 120. For example, network 140 can be the Internet, a Local Area Network, a cellular network, a public switched telephone network (“PSTN”), and/or other suitable connection(s) that enables ridesharing management system 100 to send and/or receive information between the components of the ridesharing management system 100. The network 140 can be wired and/or wireless depending on the type of connection to the network 140. Although the network 140 is shown herein as a cloud, the network 140 can include a variety of computing components, including wired and wireless components that in various networked configurations to facilitate desired communication between components.

The network 140 can support a variety of messaging formats as is known in the art, and may support a variety of services and applications for user devices 120. For example, the network 140 can support navigation services for user devices 120, such as directing users and/or ridesharing service vehicles to pick-up and/or drop-off locations.

The ridesharing management server 150 can be a system that communicates with and/or is part of a communication service provider which provides a variety of data or services, such as voice, messaging, real-time audio/video, to users, such as users 130A-130E. The ridesharing management server 150 can be a computer-based system including computer system components, desktop computers, workstations, tablets, handheld mobile communications devices, memory devices, and/or internal network(s) connecting the components.

The ridesharing management server 150 can receive information from user devices 120 over the network 140, process the information, store the information, and/or transmit information to mobile communications devices 120 over network 140. The ridesharing management server 150 can receive ride requests from user devices 120A-120C. The ridesharing management server 150 can send ride confirmation and/or ride fare information to user devices 120A-120C. The ridesharing management server 150 can send ride service assignments (e.g., including pick-up and/or drop-off location information) to driver devices 120D and 120E, and driving-control device 120F.

The ridesharing management server 150 can receive user input from user devices 120A-120C. For example, the ridesharing management server 150 can receive various ride service parameters, such as walking distance to a pick-up location, maximum delay of arrival/detour, and/or maximum number of subsequent pick-ups.

The rideshare vehicle can be a car, van, SUV, truck, bus or any kind of vehicle suitable for human transportation. In some embodiments, a vehicle is a taxi. In some embodiments, a rideshare vehicle can be an autonomous vehicle, wherein a control device integrated with the vehicle or a management system separate from the vehicle can send operational messages.

The ridesharing management server 150 can calculate ride fares based on a solo portion of a user's ride and a shared portion of the ride. The ride fare calculation can be based on various ride service parameters set by the user, such as the walking distance involved in the ride, and/or user selection regarding toll road usage.

The database 170 may include one or more physical and/or virtual storages coupled with the ridesharing management server 150. The database 170 can store user account information (e.g., registered rider and/or driver accounts) and/or corresponding user profiles (e.g., contact information, profile photos, and/or associated mobile communications device information). User account information for a rider can include ride history, service feedback, complaints, and/or comments. User account information for a driver can include number of ride service assignments completed, ratings, and/or ride service history information. The database 170 can store various ride requests received from user devices 120A-120C. Each ride request can include a corresponding starting point and desired destination information, user input regarding various service parameters, pick-up and drop-off locations, time of pick-up and drop-off, ride fares, and/or other user feedback (e.g., user comments).

The database 170 may include traffic data, maps, and/or toll road information, which may be used for ridesharing service management. The traffic data may include historical traffic data and/or real-time traffic data regarding a certain geographical region. The traffic data may be used to determine traffic conditions. Traffic data and traffic conditions can be used to estimate pick-up and drop-off times for riders and/or determine an optimal route for a particular ride or for all rides. The real-time traffic data may be received from a real-time traffic monitoring system, which may be integrated into or independent from ridesharing management system 100.

The maps may include map information (e.g., roads, streets and/or distances) typically used for navigation purposes. The map information can be used to determine potential routes and in transit routes for the rideshare vehicles and/or guiding the users to a pick-off or drop-off location. Guiding the users to a pick-up or drop off location can include displaying a map, outputting audio, displaying a list of directions or any combination thereof. The in transit routes can be modified based on adding or reducing passengers, the driver driving off the route, speed and/or other updates. Toll road information may include amount of toll charges regarding certain roads, and any change or updates thereof. Toll road information may be used to calculate ride fares. In some embodiments, a rider can specify that the rideshare vehicle route avoids toll roads.

The data stored in database 170 can be transmitted to the ridesharing management server 150 for accommodating ride requests. In some embodiments, the database 170 is stored in a cloud-based server (not shown) that is accessible by the ridesharing management server 150 and/or user devices 120 through the network 140. In some embodiments, the database 170 reside within the ridesharing management server 150.

The database 170 can include a list of ridesharing vehicles with their corresponding shift availability. The shift availability can include day, start time, stop time, maximum shift duration, and/or labor rules associated with the respective driver for the shift. The shift availability can be input by a user (e.g., a ridesharing provider).

During operation, the ridesharing management server 150 can communicate with the driving-control device 120F to direct the autonomous vehicle 130F to pick up and drop off riders 130A-130C. In some embodiments, autonomous vehicles capable of detecting objects on the road and navigate to designated locations may be utilized for providing ridesharing services.

In various embodiments, the ridesharing management server 150 is implemented on a single server or on multiple servers. Each server can be on a single computing device or distributed among multiple computing devices. In various embodiments, the ridesharing management system 100 includes multiple ridesharing management servers, and each ridesharing management server can serve a category of ridesharing services, ridesharing services associated with a certain category of service vehicles, and/or ridesharing services in a specific geographical region. For example, a first ridesharing management server can direct a first fleet of vehicles, a second ridesharing management server can direct a second fleet of vehicles and a third ridesharing server can direct a third fleet of vehicles. The first, second and third fleet of vehicles can be on-demand services, fixed-route services, or any combination thereof.

In some embodiments, a plurality of ridesharing management servers collectively provides a dynamic and integrated ridesharing service system.

As shown in FIG. 1, users 130A-130E may include a plurality of users 130A-130C, and a plurality of drivers 130D and 130E, who may communicate with one another, and with ridesharing management server 150 using various types of user devices 120 that are mobile communications devices. For example, the mobile communications device can include a display such as a television, tablet, computer monitor, video conferencing console, or laptop computer screen. A mobile communications device 120 can further include video/audio input devices such as a microphone, video camera, keyboard and/or web camera. A mobile communications device 120 can include mobile devices such as a tablet or a smartphone having display and/or video/audio capture capabilities. The mobile communications device can include one or more software applications that can facilitate the mobile communications devices to engage in communications, such as IM, VOIP, video conferences. For example, user devices 130A-130C can send requests to ridesharing management server 150, and receive confirmations therefrom. Drivers 130D and 130E can use their respective user devices to receive ride service assignments and navigation information from ridesharing management server 150, and may contact the users with their respective user devices.

In some embodiments, a user may directly hail a vehicle by hand gesture or verbal communication, such as traditional street vehicle hailing. In such embodiments, once a driver accepts the request, the driver can use his respective user device to input the ride request information. Ridesharing management server 150 can receive the information, and accordingly assign one or more additional ride service assignments to the same vehicle, for example, subsequent ride requests received from other user devices 120 through network 140.

In some embodiments, driver devices 120D and 120E, and driving-control device 120F may be embodied in a vehicle control panel, as a part of the vehicle control system associated with a particular vehicle. For example, a traditional taxi company may install a drive device in all taxi vehicles managed by the taxi company. In some embodiments, driver devices 120D and 120E, and driving-control device 120F, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device, without using a user device providing ridesharing service.

In some embodiments, the rideshare management server 150 can receive a list of ride requests from a user (e.g., a rideshare provider, not shown). The rideshare management system can receive the list of ride requests for a predefined time period, e.g., at night for the following day, for a scheduled 24 period, or any defined time period. Each ride in the list of ride requests can include a pick-up location, drop-off location, desired pick-up time, desired drop off time, maximum delay between desired pick-up time and actual pick-up time, maximum delay between desired drop off time and actual drop-off time, maximum distance between pick-up location and actual pick-up location, maximum distance between drop-off location and actual drop-off location, or any combination thereof.

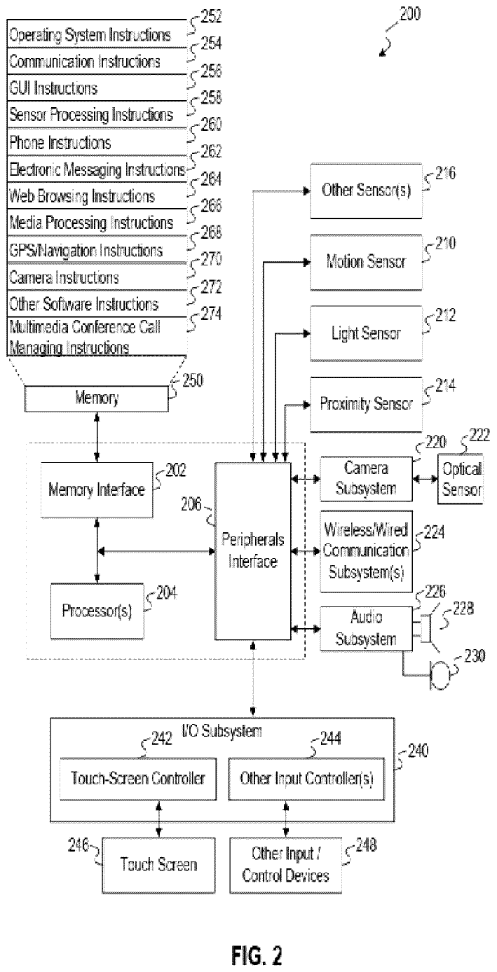

FIG. 2 is a diagram of a mobile communications device 200 (e.g., user device 120 100 as shown above in FIG. 1) associated with a ridesharing management system (e.g., ridesharing management system 100 as shown above in FIG. 1), according to some embodiments of the invention. The mobile communications device 200 can be used to implement computer programs, applications, methods, processes, or other software to perform embodiments of the invention described in herein. For example, turning back to FIG. 1, rider devices 120A-120C, driver devices 120D and 120E, and driving-control device 120F may respectively be installed with a rider side ridesharing application, and a corresponding driver side ridesharing application.

Turning back to FIG. 2, the mobile communications device 200 can include a memory interface 202, one or more processors 204 such as data processors, image processors and/or central processing units, and/or a peripherals interface 206. The Memory interface 202, one or more processors 204, and/or peripherals interface 206 can be separate components or can be integrated in one or more integrated circuits. The various components in mobile communications device 200 may be coupled by one or more communication buses or signal lines.

Sensors, devices, and subsystems can be coupled to peripherals interface 206 to facilitate multiple functionalities. For example, a motion sensor 210, a light sensor 212, and a proximity sensor 214 may be coupled to peripherals interface 206 to facilitate orientation, lighting, and/or proximity functions. One or more sensors 216 can be connected to peripherals interface 206, such as a positioning system (e.g., GPS receiver), a temperature sensor, a biometric sensor, and/or other sensing devices. A GPS receiver can be integrated with, or connected to, mobile communications device 200. For example, a GPS receiver may be included in mobile telephones, such as smartphone devices. GPS software can allow mobile telephones to use an internal and/or external GPS receiver (e.g., connecting via a serial port or Bluetooth). A camera subsystem 220 and/or an optical sensor 222, e.g., a charged coupled device (“CCD”) or a complementary metal-oxide semiconductor (“CMOS”) optical sensor, can be used to facilitate camera functions, such as recording photographs and video clips.

Communication functions can be facilitated through one or more wireless/wired communication subsystems 224, which can include an Ethernet port, radio frequency receivers and transmitters and/or optical (e.g., infrared) receivers and/or transmitters. The specific design and implementation of wireless/wired communication subsystem 224 may depend on the communication network(s) over which mobile communications device 200 is intended to operate. For example, in some embodiments, mobile communications device 200 may include wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and/or telephony functions.

I/O subsystem 240 may include touch screen controller 242 and/or other input controller(s) 244. Touch screen controller 242 may be coupled to touch screen 246. Touch screen 246 and touch screen controller 242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 may be coupled to other input/control devices 248, such as one or more buttons, rocker switches, thumb-wheel, infrared port, USB port, and/or a pointer device such as a stylus. Touch screen 246 may, for example, also be used to implement virtual or soft buttons and/or a keyboard.

Memory interface 202 may be coupled to memory 250. Memory 250 includes high-speed random access memory and/or non-volatile memory, such as one or more magnetic disk storage devices, one or more optical storage devices, and/or flash memory (e.g., NAND, NOR). Memory 250 may store an operating system 252, such as DRAWIN, RTXC, LINUX, iOS, UNIX, OS X, WINDOWS, or an embedded operating system such as VXWorkS. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions.

In some embodiments, communication instructions 254 may include software applications to facilitate connection with ridesharing management server (e.g., ridesharing management server 150 as described above in FIG. 1) that handles vehicle ridesharing requests. Graphical user interface instructions 256 may include a software program that facilitates a user associated with the mobile communications device to receive messages from ridesharing management server 150, provide user input, and so on. For example, a user may send ride requests and ride service parameters to a ridesharing management server and receive ridesharing proposals and confirmation messages. A driver may receive ride service assignments from ridesharing management server, and provide ride service status updates.

Each of the above identified instructions and applications may correspond to a set of instructions for performing one or more functions described above. These instructions need not be implemented as separate software programs, procedures, or modules. Memory 250 may include additional instructions or fewer instructions. Furthermore, various functions of mobile communications device 200 may be implemented in hardware and/or in software, including in one or more signal processing and/or application specific integrated circuits.

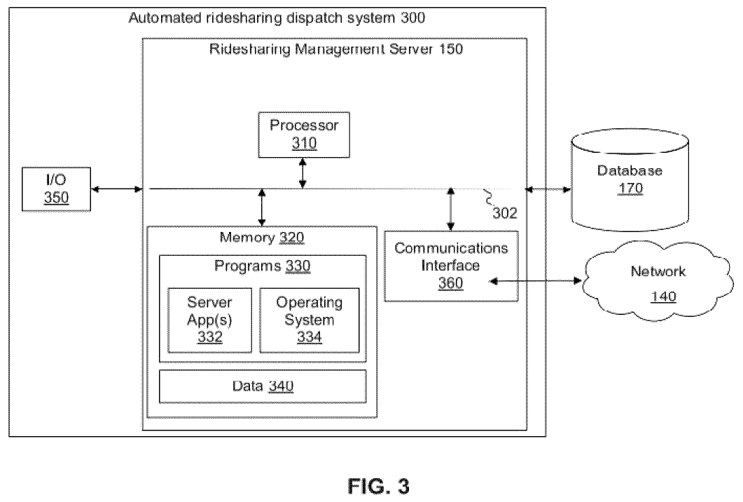

FIG. 3 is a diagram of an automated ridesharing dispatch system 300, including a ridesharing management server (e.g., ridesharing management server 150 as described above in FIG. 1) associated with a ridesharing management system (e.g., ridesharing management system 100 as described above in FIG. 1), according to some embodiments of the invention. The ridesharing management server 150 can include a bus 302 (or other communication mechanism), which interconnects subsystems and/or components for transferring information within the ridesharing management server 150.

As shown in FIG. 3, automated ridesharing dispatch system 300 may include one or more processors 310, one or more memories 320 storing programs 330 including, for example, server app(s) 332, operating system 334, and data 340, and a communications interface 360 (e.g., a modem, Ethernet card, or any other interface configured to exchange data with a network, such as network 140 in FIG. 1). Automated ridesharing dispatch system 300 can communicate with an external database (e.g., external databased 170 as described above with respect to FIG. 1). Automated ridesharing dispatch system 300 can include a single server (e.g., ridesharing management server 150) and/or can be configured as a distributed computer system including multiple servers, server farms, clouds, and/or computers that can interoperate to perform one or more of the processes and functionalities associated with embodiments.

The ridesharing management server 150 can be a computer platform that provides services via a network, such as the Internet, it can use virtual machines that may not correspond to individual hardware. The computational and/or storage capabilities can be implemented by allocating appropriate portions of desirable computation/storage power from a scalable repository, such as a data center and/or a distributed computing environment.

Processor 310 may be one or more processing devices configured to perform functions of the disclosed methods, such as a microprocessor manufactured by Intel™ or manufactured by AMD™. Processor 310 can include a single core or multiple core processors executing parallel processes simultaneously. For example, processor 310 may be a single core processor with virtual processing technologies. In some embodiments, processor 310 can uses logical processors to simultaneously execute and/or control multiple processes. Processor 310 can implement virtual machine technologies, and/or other technologies to provide the ability to execute, control, run, manipulate, and/or store multiple software processes, applications, programs. In some embodiments, processor 310 includes a multiple-core processor arrangement (e.g., dual and/or quad core) to provide parallel processing functionalities to allow ridesharing management server 150 to execute multiple processes simultaneously. It is appreciated by one of ordinary skill in the art that other types of processor arrangements can be implemented that provide for the capabilities disclosed herein.

Memory 320 can be a volatile or non-volatile, magnetic, semiconductor, tape, optical, removable, non-removable, or other type of storage device or tangible or non-transitory computer-readable medium that stores one or more program(s) 330 such as server apps 332 and operating system 334, and data 340. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The ridesharing management server (e.g., ridesharing management server 150 as described above in FIG. 1) can include one or more storage devices configured to store information used by processor 310 (or other components) to perform certain functions related to the embodiments. For example, the ridesharing management server may include memory 320 that includes instructions to enable processor 310 to execute one or more applications, such as server apps 332, operating system 334, and/or any other type of application or software known to be available on computer systems. In some embodiments, the instructions, and/or application programs, can be stored in an external database 170 (which can also be internal to ridesharing management server 150) or external storage communicatively coupled with ridesharing management server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 320 and database 170 may include one or more memory devices that store data and instructions used to perform one or more features of the disclosed embodiments. Memory 320 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, ridesharing management server 150 may be communicatively connected to one or more remote memory devices (e.g., remote databases (not shown)) through network 140 or a different network. The remote memory devices can be configured to store information that ridesharing management server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 330 may include one or more software modules causing processor 310 to perform one or more functions of the disclosed embodiments. Moreover, processor 310 may execute one or more programs located remotely from one or more components of the ridesharing management system 100. For example, ridesharing management server 150 may access one or more remote programs that, when executed, perform functions related to disclosed embodiments.

In the presently described embodiment, server app(s) 332 may cause processor 310 to perform one or more functions of the disclosed methods. For example, devices associated with users, drivers and autonomous vehicles may respectively be installed with user applications for vehicle ridesharing services, and driver applications for vehicle ridesharing services. Further, a mobile communications device may be installed with both the driver applications and the user applications, for uses in corresponding situations.

In some embodiments, other components of ridesharing management system 100 may be configured to perform one or more functions of the disclosed methods. For example, mobile communications devices 120 may be configured to calculate estimate pick-up and drop-off times based on a certain ride request, and may be configured to calculate estimate ride fares. As another example, mobile communications devices 120 may further be configured to provide navigation service, and location service, such as directing the user to a particular pick-up or drop-off location, and providing information about a current location of the respective user or vehicle to ridesharing management server 150.

In some embodiments, program(s) 330 may include operating system 334 performing operating system functions when executed by one or more processors such as processor 310. By way of example, operating system 334 may include Microsoft Windows™, Unix™, Linux™, Apple™ operating systems, Personal Digital Assistant (PDA) type operating systems, such as Apple IOS, Google Android, Blackberry OS, Microsoft CE™, or other types of operating systems. Accordingly, the disclosed embodiments may operate and function with computer systems running any type of operating system 334. Ridesharing management server 150 may also include software that, when executed by a processor, provides communications with network 140 through communications interface 360 and/or a direct connection to one or more mobile communications devices 120. Specifically, communications interface 360 may be configured to receive ride requests (e.g., from user devices 120A-120C) headed to differing destinations, and receive indications of the current locations of the ridesharing vehicles (e.g., from driver devices 120D and 120E or driving-control device 120F). In one example, communications interface 360 may be configured to continuously or periodically receive current vehicle location data for the plurality of ridesharing vehicles that are part of ridesharing management system 100. The plurality of ridesharing vehicles can be a car fleet, bus fleet or any combination thereof. The current vehicle location data may include global positioning system (GPS) data generated by at least one GPS component of a mobile communications device 120 associated with each ridesharing vehicle.

In some embodiments, data 340 may include, for example, profiles of users, such as user profiles or driver profiles. User profiles can include contact information, profile photos, user account information and/or associated mobile communications device information. Rider account information can include ride history, service feedbacks, complaints, and/or comments. Driver account information can include number of ride service assignments completed, ratings, ride service history, rider ride history, driver service record, and/or communications between a driver and a rider regarding a particular ride request. In some embodiments, data 340 may further include traffic data, toll road information, and navigation information, which may be used for handling and accommodating ride requests.

Automated ridesharing dispatch system 300 may also include one or more I/O devices 350 having one or more interfaces for receiving signals or input from devices and providing signals or output to one or more devices that allow data to be received and/or transmitted by automated ridesharing dispatch system 300. For example, automated ridesharing dispatch system 300 may include interface components for interfacing with one or more input devices, such as one or more keyboards, mouse devices, and the like, that enable automated ridesharing dispatch system 300 to receive input from an operator or administrator (not shown).

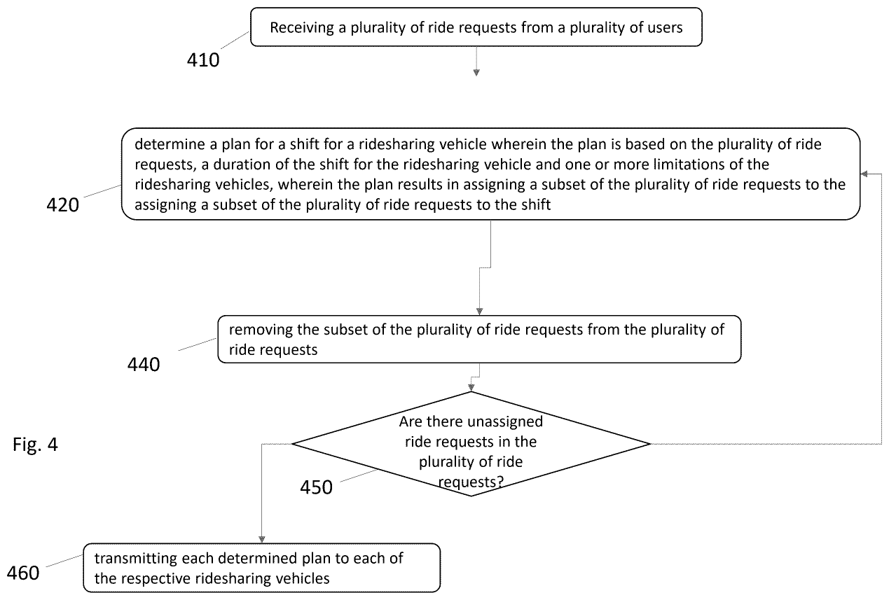

FIG. 4 is a flowchart for a method for managing (e.g., via a rideshare management server 150 over a network 140, as described above in FIG. 1) a fleet of ridesharing vehicles (e.g., users in fleet 130D, 130E, and 130F, as described above in FIG. 1), according to some embodiments of the invention.

The method involves receiving (e.g., via the communications interface 360 as described above with respect to FIG. 3) a plurality of ride requests from a plurality of users (Step 405). The plurality of ride requests can be received a minimum amount of time before a start time of the soon ride request in the plurality of ride requests. For example, the minimum amount of time can be 12 hours, 24 hours, or any amount of time. The plurality of ride requests can be for a predefined time period. The predefined time period can be a 12 hour period, 24 hour period or any hour period.

Each ride in the list of ride requests can include a pick-up location, drop-off location, desired pick-up time, desired drop off time, maximum delay between desired pick-up time and actual pick-up time, maximum delay between desired drop off time and actual drop-off time, maximum distance between pick-up location and actual pick-up location, maximum distance between drop-off location and actual drop-off location, or any combination thereof.

For example, assume there are three ride requests in the plurality of ride requests, as shown below in Table 1.

TABLE 1

| | Pickup time | Dropoff time | | | |
|---|---|---|---|---|---|
| Rider Id | request | request | Pickup location | Dropoff location | Request Tags |
| 1 | 13:15 | | 1 The Origin, | 1 The Dest, | [Wheelchair] |
| | | | NY, NY | NY, NY | |
| 2 | | 11:30 | 10 The Origin, | 10 The Dest, | |
| | | | NY, NY | NY, NY | |
| 3 | 16:20 | 17:10 | 100 The Origin, | 100 The Dest, | [Ambulatory] |
| | | | NY, NY | NY, NY | |

The method can also involve determining a plan for a shift of a ridesharing vehicle wherein the plan is based on the plurality of ride requests, a duration of the shift for the ridesharing vehicle and one or more limitations of the ridesharing vehicles, wherein the plan results in assigning a subset of the plurality of ride requests to the shift (Step 420).

The one or more limitations can include a maximum duration a driver can continuously drive, a number of breaks, a duration for each break, a minimal time for a shift and/or a total length of the shift. The plan can include a start time, and end time, a driver start break time and a driver end break time.

In various embodiments, the one or more limitations are based on driver fatigue rules where the driver fatigue rules are based on a total drive time over a predetermined drive period (e.g., 10 hours, 12 hours, or 24 hours), and/or a continuous drive time (e.g., 3 hours, 4 hours, or 5 hours). For example, the one or more limitations can include a total drive time of 10 hours, a duration for each break of 1 hour, a number of breaks of 1 hour and maximum duration a driver can continuously drive of 4 hours. In this example, the plan can be determined to be first 4 hour shift followed by a one hour break and a second four hour shift with a second one hour break.

In some embodiments, a plan is determined for an entire duration of a shift (e.g., hourly, hours and minutes, or any time duration input). The entire duration of a shift can be an entire duration of the service day. An optimization can be performed on the shift of the entire duration such that the shift duration can be reduced. The optimization can be to determine a window within the entire duration of the shift that maximizes utilization based on one or more limitations (e.g., the one or more limitations as described above).

Table 2 shows an example of a plan for an entire shift.

TABLE 2

| | | Dropoff time | | |
|---|---|---|---|---|
| | Pickup time | request (if | | |
| Rider Id | request | provided) | From Location | To Location |
| 1 | 6:12 | | L1 | L2 |
| 2 | 6:25 | | L3 | L4 |
| 3 | 7:10 | | L5 | L6 |
| 4 | 7:15 | | L7 | L8 |
| 5 | 7:30 | | L9 | L10 |
| 6 | 8:05 | | L11 | L12 |

In some embodiments, determining the plan for a shift of the ridesharing vehicle can involve segmenting the plan that is based on the entire duration of the shift, and determining which segments are optimal. The segments can be determined by splitting the plan for the entire duration based on when the vehicle is empty. In some embodiments, the splitting is done before every pickup and drop off. In some embodiments, the splitting is done even when there are passengers in the vehicle by ignoring them from the plan, after a predetermined duration. In these embodiments, the passengers remain for the next iteration.

Determining the plan for the shift for each segment can involve for each potential first pick-up location, determine a distance to the nearest vehicle depot, and for each potential last drop-off, determine a distance to the vehicle depot. Determining the plan for the shift for each segment can involve for each segment determining a shift length and utilizations. The utilizations can be determined by dividing a number of rides between the first pick-up location of the segment and the final drop-off location of the segment and dividing by the length of the shift of the segment.

Determining the plan for the ridesharing vehicle can also involve selecting a segment with the most utilizations. If one or more segments have the highest utilizations that are equal, the segment can be randomly chosen between the pairs with the highest utilizations.

In some embodiments, when the plan is determined it is determined for a shift that has one or more limitations that are not specific to any particular ridesharing vehicle. In this manner, a plurality of shifts, e.g., if there are a plurality of rides to be assigned that don't fit into one shift based on the one or more limitations, can have plans determined, and after the plans are determined, the plans can be assigned to particular ridesharing vehicles based on availability of the particular ridesharing vehicle.

In some embodiments, when the plan is determined, it is determined for a shift that has one or more limitations that are specific to a particular ridesharing vehicle (e.g., a start location that is not the depot where the ridesharing vehicle is located or number of passenger seats) such that the plan is assigned to the particular ridesharing vehicle. In these embodiments, plans can be made for specific vehicles in a fleet.

The method can also involve removing the subset of the plurality of ride requests from the plurality of ride requests (Step 440). Continuing with the above example, ride requests #1-5 are assigned to vehicle #1, and thus they are removed from the plurality of ride requests which includes 20 ride requests. Thus, the plurality of ride requests is now 15.

The method can also involve determining if there are unassigned ride requests in the plurality of ride requests (Step 450), and if so, going back to step 420. Continuing with the above example, there are 15 unassigned ride requests, thus in this example the method goes back to step 420. As is apparent to one of ordinary skill in the art, once all of the ride request in the plurality of ride requests are planned, the method can move on to Step 460, as described below.

The method can also involve transmitting each determined plan to each of the respective ridesharing vehicles (Step 460).

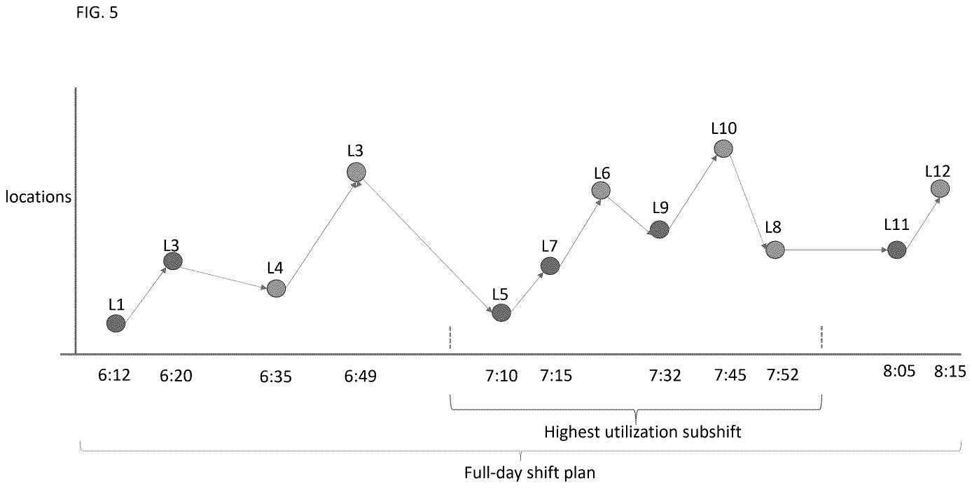

FIG. 5 shows a graph of a plan for an entire shift and an optimal segment, according to some embodiments of the invention. The graph shows the entire shift extends from time 6:12 to 8:15, and the plan entails picking up rider 1 at location L1, rider 2 at location L3, dropping of rider 1 at location L4 and so forth. The graph also shows an example of a segment from L5 to L8 that can be an optimal segment (e.g., highest utilization subshift) that can be determined, for example, using the method as described above in FIG. 4. For example, assume that after measuring the distance of each pick-up and drop-off from the nearest depot, the optimal subshift is from the pick-up of rider 3 until the drop-off of rider 5. Assume the nearest depot to location L5 (the first pickup in the subshift) is 7 minutes away, and the nearest depot to location L10 (the last dropoff in the subshift) is 90 minutes away, then the final shift will start at 7:03 and end at 7:59. Accordingly, FIG. 5 shows an example of a determined optimal plan.

In some embodiments, each plan is assigning to a ridesharing vehicle. The assigning can be done automatically by the ridesharing management system. The ridesharing management system can determine vehicles from the fleet of vehicles having availability that matches plans, such that each vehicle is assigned one matching plan.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A system for managing a fleet of ridesharing vehicles, the system comprising:
a communications interface configured to a plurality of ride requests from a plurality of users;
at least one processor configured to:
i) determine a plan for a shift of a ridesharing vehicle wherein the plan is based on the plurality of ride requests, a duration of the shift for the ridesharing vehicle and one or more limitations of the ridesharing vehicles, wherein the plan results in assigning a subset of the plurality of ride requests to the shift;
ii) removing the subset of the plurality of ride requests from the plurality of ride requests; and
iii) if there are remaining unassigned plurality of ride requests, returning to step i), otherwise, transmitting each determined plan to each of the respective ridesharing vehicles.

2. The system of claim 1 wherein the plurality of ride requests are received over a predefined time duration.

3. The system of claim 1 wherein the plurality of ride requests includes pick-up time and pick-up location.

4. The system of claim 1 wherein each plan includes a start time, an end time, a driver start break time and a driver end break time.

5. The system of claim 1 wherein the one or more limitations includes a maximum duration a driver can continuously drive, a number of breaks, a duration for each break, minimal time for a shift, total length of the shift, or any combination thereof.

6. The system of claim 1 wherein to determine a plan, the processor is further configured to:
segment the shift and determine an optimal shift from the segments, wherein segmenting is based on when the vehicle is empty, before every pick up and drop off, after a predetermined duration or any combination thereof, and
wherein determining an optimal shift is based on a distance of each segment's potential first pick-up location to a nearest vehicle depot, distance for each potential last drop-off to a nearest vehicle depot, utilizations for the segment, shift length or any combination thereof.

7. The system of claim 1 wherein the processor is further configured to assign each determined plan to a corresponding vehicle.

8. A method for managing a fleet of ridesharing vehicles, the method comprising:
receiving, via a communications interface, a plurality of ride requests from a plurality of users;
i) determining, via a processor, a plan for a shift of the ridesharing vehicle wherein the plan is based on the plurality of ride requests, a duration of the shift for the ridesharing vehicle and one or more limitations of the ridesharing vehicles, wherein the plan results in assigning a subset of the plurality of ride requests to the shift;
ii) removing, via the processor the subset of the plurality of ride requests from the plurality of ride requests; and
iii) if there are remaining unassigned plurality of ride requests, returning to step i), otherwise, transmitting each determined plan to each of the respective ridesharing vehicles.

9. The method of claim 8 wherein the plurality of ride requests are received over a predefined time duration.

10. The method of claim 8 wherein the plurality of ride requests includes pick-up time and pick-up location.

11. The method of claim 8 wherein each plan includes a start time, an end time, a driver start break time and a driver end break time.

12. The method of claim 8 wherein the one or more limitations includes a maximum duration a driver can continuously drive, a number of breaks, a duration for each break, minimal time for a shift, total length of the shift, or any combination thereof.

13. The method of claim 8 wherein determining a plan further comprises
segmenting the shift and determine an optimal shift from the segments, wherein segmenting is based on when the vehicle is empty, before every pick up and drop off, after a predetermined duration or any combination thereof, and
wherein determining an optimal shift is based on a distance of each segment's potential first pick-up location to a nearest vehicle depot, distance for each potential last drop-off to a nearest vehicle depot, utilizations for the segment, shift length or any combination thereof.

14. The method of claim 8 further comprising assigning each determined plan to a corresponding vehicle.
